(19) United States
(12) Patent Application Publication
(10) Pub. No.: US 2007/0241644 A1
(43) Pub. Date: Oct. 18, 2007

(54) SINGLE-PHASE MOTOR

(76) Inventors: Shigeru Kakugawa, Hitachi (JP); Shoichi Kawamata, Hitachi (JP); Fumio Tajima, Hitachi (JP); Osamu Sekiguchi, Ryugasaki (JP); Shoji Ohiwa, Saitama (JP); Yukinari Takahashi, Kiryu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/734,307

(22) Filed: Apr. 12, 2007

(30) Foreign Application Priority Data
Apr. 14, 2006 (JP) 2006-111504
Nov. 22, 2006 (JP) 2006-315194

(51) Int. Cl. H02K 7/00; H02K 1/06; H02K 1/12

(52) U.S. Cl. 310/67 R; 310/254; 417/354; 310/217; 310/DIG. 6

(57) ABSTRACT

A single-phase motor comprising a rotor magnet, a stator core having salient poles, and a coil wound around the stator core, a rising portion and a falling portion of a voltage applied to the coil have different inclinations, wherein the salient pole is separated into three angle portions, a radius of an outer shape of the salient pole is reduced little by little with respect to a rotating direction of the rotor in a first angle portion with respect to the rotating direction of the rotor, is increased little by little with respect to the rotating direction of the rotor in a second angle portion with respect to the rotating direction of the rotor, and is increased little by little with respect to the rotating direction of the rotor in a third angle portion with respect to the rotating direction of the rotor, and a rate of increase of the third angle portion is gentler than that of the second angle portion. Accordingly, it is possible to provide a single-phase motor having a small torque pulsation, a low noise and a low vibration.

### FIELD OF THE INVENTION

The present invention relates to a single-phase motor.

### DESCRIPTION OF RELATED ART

Since a structure of a single-phase motor is simpler in comparison with a poly-phase motor, the single-phase motor is generally inexpensive. Accordingly, the single-phase motor is employed in an electric machine in which a cost saving is required. As a representative example, an example of a two-phase DC brushless motor is disclosed in JP-A-11-332193. This example is successful in a reduction of a torque pulsation to a certain limit by separating a stator core into a part of which an outer diameter is increased little by little and a part of which an outer diameter is fixed appropriately so as to set a first half of an induced voltage to a sine wave and a second half to a rectangular wave. As a typical example of the electric machine utilizing the single-phase motor, there can be listed up a fan motor. A lot of axial fan motors for cooling are used in household appliances and various office automation (OA) and information technology (IT) devices. In these products, in order to reduce a heating value and a product cost, an increase of airflow quantity is demanded. In accordance with an increase of the airflow quantity, there is a tend to enlarge a noise caused by an electromagnetic exciting force and a blade rotation. On the other hand, a demand of reducing the noise becomes larger in pursuit of a comfortable environment, and a technique to the demand has been developed.

As a technique for reducing a vibration and a noise of the product into which the axial fan motor is built, in JP-A-10-159792, it is intended to reduce the vibration by setting a vibration proof rubber between a motor shaft and a fan boss.

In the single-phase motor, since two torque pulsations are generated in one cycle of an electrical angle in principle, there is a problem that the noise and the vibration are large. Accordingly, there have been executed various attempts such as an attempt of devising a shape of a stator core so as to control wave forms of an induced voltage and a cogging torque and make an output torque pulsation small, an attempt of controlling a magnetization distribution of a rotor magnet, and the like. Any attempt attains some progress so as to contribute to a reduction of the torque pulsation, however, the torque pulsation generated from the elemental problem mentioned above remains in a level causing a problem in terms of the noise and the vibration of the electrical device using the single-phase motor. Accordingly, there is a problem that the output torque pulsation is to be made smaller in accordance with a low noise and a low vibration of the electrical machine. Further, the output torque wave form of the motor is determined by a wave form of the induced voltage and a wave form of the current. Therefore, it is best to simultaneously control the shape of the stator core and the wave form of the applied voltage, however, since the prior art has not been under review from this point of view, there is a problem that the reduction of the torque pulsation is insufficient.

### BRIEF SUMMARY OF THE INVENTION

Accordingly, an object of the present invention is to provide a single-phase motor having a small output torque pulsation, a low noise and a low vibration.

In order to achieve the object, in accordance with the present invention, there is provided a single-phase motor comprising a rotor magnet, a stator core having salient poles, and a coil wound around the stator core, wherein a rising portion and a falling portion of a voltage applied to the coil have different inclinations from each other, the salient pole of the stator core is separated into three angle portions, a radius of an outer shape of the salient pole is reduced little by little with respect to a rotating direction of the rotor in the first angle portion with respect to the rotating direction of the rotor, is increased little by little with respect to the rotating direction of the rotor in the second angle portion with respect to the rotating direction of the rotor, and is increased little by little with respect to the rotating direction of the rotor in the third angle portion with respect to the rotating direction of the rotor, and a rate of the increase in the third angle portion is gentler than that in the second angle portion.

In accordance with the present invention, it is possible to provide the single-phase motor having the small torque pulsation, the low noise and the low vibration.

Other objects, features and advantages of the invention will become apparent from the following description of the embodiments of the invention taken in conjunction with the accompanying drawings.

### BRIEF DESCRIPTION OF THE SEVERAL VIEWS OF DRAWING

FIG. 1 shows a first embodiment of a single-phase motor in accordance with the present invention;

FIG. 2 shows one example of a wave form of a driving voltage of the single-phase motor in the first embodiment in accordance with the present invention;

FIG. 3 shows one example of a relation between a lead angle of the driving voltage and a peak to peak (pp) value of a torque pulsation;

FIG. 4 shows one example of a relation between an angle position of a parting line 9 and the pp value of the torque pulsation;

FIG. 5 shows one example of a relation between an angle position of a parting line 8 and the pp value of the torque pulsation;

FIG. 6 shows one example of a wave form of an induced voltage of the single-phase motor in the first embodiment in accordance with the present invention;

FIG. 7 shows one example of a wave form of a current-carrying torque of the single-phase motor in the first embodiment in accordance with the present invention;

FIG. 8 shows one example of a wave form of an output torque of the single-phase motor in the first embodiment in accordance with the present invention;

FIG. 9 shows one example of a view of a whole structure of an axial fan motor in a second embodiment in accordance with the present invention;

FIG. 10 shows one example of a stator core of a single-phase motor in the second embodiment in accordance with the present invention;

FIG. 11 shows a structure of a sleeve in the second embodiment in accordance with the present invention;

FIG. 12 shows the structure of the sleeve in the second embodiment in accordance with the present invention;

FIG. 13 shows one example of the stator core of the single-phase motor in the second embodiment in accordance with the present invention;

FIG. 14 shows a cross sectional view of the single-phase motor in the second embodiment in accordance with the present invention;

FIG. 15 shows a result of analysis of a magnetic field of a stator core in a comparative embodiment;

FIG. 16 shows a result of analysis of a magnetic field of the stator core in the second embodiment in accordance with the present invention; and

FIG. 17 shows a torque ripple of the motors of the comparative embodiment, and the first and second embodiments in accordance with the present invention.

### DETAILED DESCRIPTION OF THE INVENTION

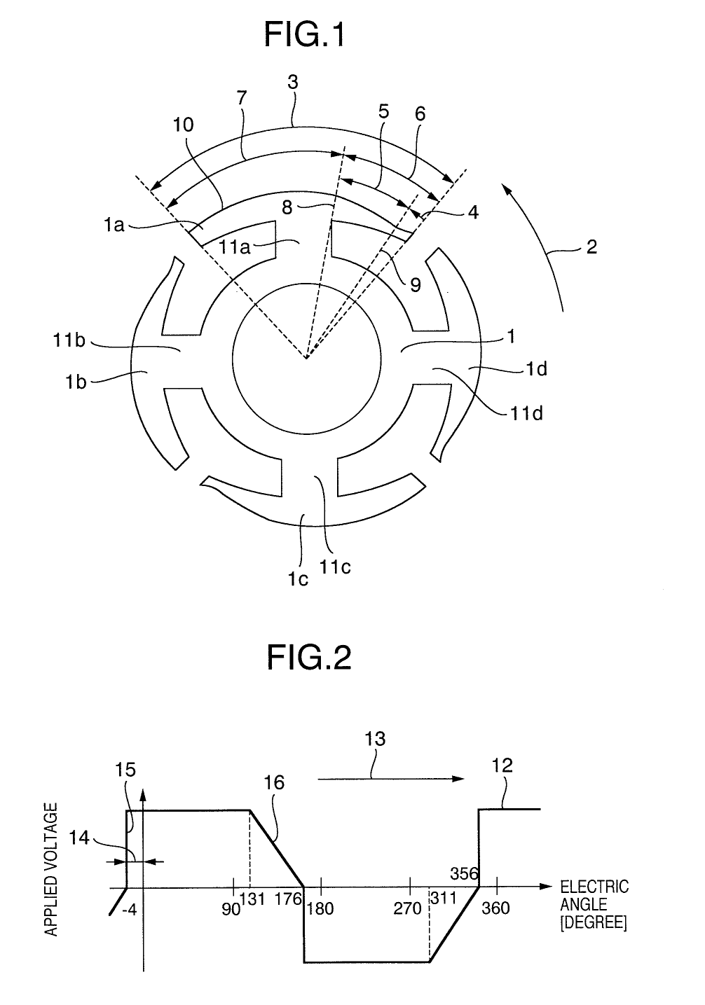

A description will be given below of a structure of a single-phase motor in accordance with a first embodiment of the present invention with reference to FIGS. 1 to 5.

FIG. 1 shows a stator core 1 in accordance with a first embodiment of the present invention. The stator core 1 is constituted by four salient poles 1a, 1b, 1c and 1d. The salient poles 1a, 1b, 1c and 1d are formed in the same shape. Further, although an illustration is omitted, a rotor core having a rotor magnet is provided on an outer side in a radial direction of the stator core 1, and is rotated in a rotating direction 2. A description will be given below of a structure of the salient pole by using the salient pole 1a. In the salient pole 1a, a whole angle 3 with respect to the rotating direction 2 can be divided into angle regions 4, 5 and 7 by parting lines 8 and 9 as illustrated. In this case, the whole angle 3 is set to 80.6 degree, the angle 4 defining the parting line 9 is defined at a position of 8% with respect to the whole angle 3, and the angle 6 defining the parting line 8 is defined at a position of 36.5% with respect to the whole angle 3. A radius of an outer shape 10 of the salient pole 1a from a center of the stator core 1 is determined in such a manner as to be reduced little by little with respect to the rotating direction 2 in a portion of the angle region 4, be increased little by little with respect to the rotating direction 2 in a portion of the angle region 5, and, be increased little by little with respect to the rotating direction 2 but slower than that of the angle region 5 in a portion of the angle region 7. It is possible to structure the good single-phase motor having a small torque pulsation in a combination with an applied voltage mentioned below, by setting the shape of the rotor core as mentioned above.

FIG. 2 shows an applied voltage 12 applied to a coil (not shown) wound around teeth portions 11a, 11b, 11c and 11d of the stator core in FIG. 1. In the motor, an electric current is applied to the coil by the applied voltage, and a torque is generated, so as to turn the rotor. An axis of ordinate of a graph in FIG. 2 shows the applied voltage, an abscissa axis shows an electrical angle (degree), and they have an illustrated relation with respect to a rotating direction 13 of the rotor. An origin of the ordinate axis is brought into line with a generation point of an induced voltage (not shown). The applied voltage 12 advances only a lead angle 14 with respect to the generation point of the induced voltage, as illustrated. In the present embodiment, the lead angle 14 is set to 4 degrees by an electrical angle. A rising portion 15 and a falling portion 16 of the applied voltage 12 are determined asymmetric as illustrated. In the present embodiment, an inclination of the rising portion is substantially rectangular, and an inclination of the falling portion is set to 40 to 50 degrees, preferably 45 degrees of a half period of the applied voltage 12. In this case, the electrical angle (degree) of each of the points in FIG. 2 is shown in the drawing. Applying an inclination to a voltage wave forms of the rising portion and the falling portion is called as a soft switching. There can be considered that the soft switching is achieved by a pulse width modulation (PWM) of the applied voltage by means of an inverter. However, in this case, the structure is made such that a voltage wave form in the case of smoothening an aggregate of the rectangular voltages by PWM with time is inclined approximately linearly as illustrated. As mentioned above, there is obtained an effect of achieving both of reduction of a high-order torque pulsation and reservation of a voltage capacity factor, and reducing a low-order torque pulsation, by applying a soft switching to the rising portion of the applied voltage. Further, there is obtained an effect of further reducing the torque pulsation by applying the lead angle as illustrated.

The shape of the stator core and the wave form of the applied voltage shown in FIGS. 1 and 2 vary depending on each other, however, can be obtained as an optimum value on the basis of an optimization calculation obtained by combining an electromagnetic field analysis and a circuit analysis.

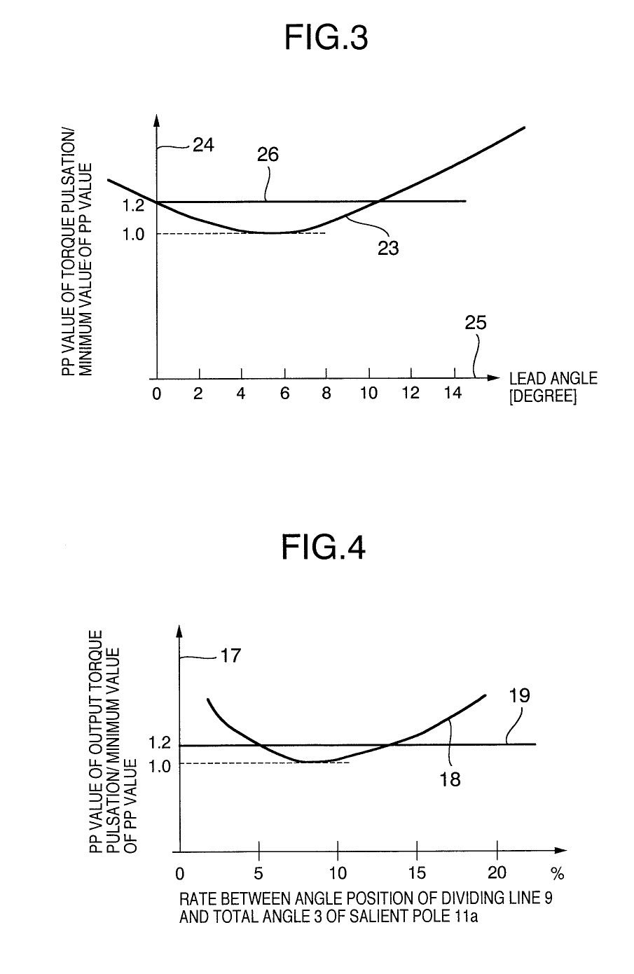

FIG. 3 shows a peak to peak (pp) value 23 of an output torque pulsation of the motor in which a minimum value is standardized to 1, in the case that the lead angle 14 in FIG. 2 is set to a parameter, by an axis of ordinate 24. An abscissa axis indicates a lead angle 25 in which a unit is “degree” in the electrical angle. The minimum value is at a position of 6 degrees of the abscissa axis, and the pp value of the output torque pulsation of the motor is increased regardless of increasing or decreasing a magnitude of the lead angle 14, so that a performance is deteriorated. An increase of the torque pulsation can be allowed up to 20%, an allowable value of the torque pulsation increase is shown by a line 26 which is about 1.2 times of the minimum value, and intersecting points between the line 26 and the graph 23 are determined as 0 degree and 10 degree on an abscissa axis. Accordingly, if the lead angle exists between 0 degree and 10 degrees, the motor has an improved output torque pulsation characteristic.

FIG. 4 shows a peak to peak (pp) value 18 of the output torque pulsation of the motor in which a minimum value is standardized to 1, in the case that the angle position of the parting line 9 in FIG. 1 is shown by a rate relative to the whole angle 3 of the salient pole 11a with respect to the rotating direction 2 of the rotor, by an axis of ordinate 17. The minimum value is at a position of 7.93% on the abscissa axis, and the pp value of the output torque pulsation of the motor is increased regardless of increasing or decreasing a magnitude of the angle position of the parting line 9, so that a performance is deteriorated. An increase of the torque pulsation can be allowed up to 20%, an allowable value of the torque pulsation increase is shown by a line 19 which is about 1.2 times of the minimum value, and intersecting points between the line 19 and the graph 18 are determined as 4% and 13% on the abscissa axis. Accordingly, if the value indicating the angle position of the parting line 9 by the rate to the whole angle 3 of the salient pole 11a with respect to the rotating direction of the rotor exists between 4% and 13%, the motor has an improved output torque pulsation characteristic.

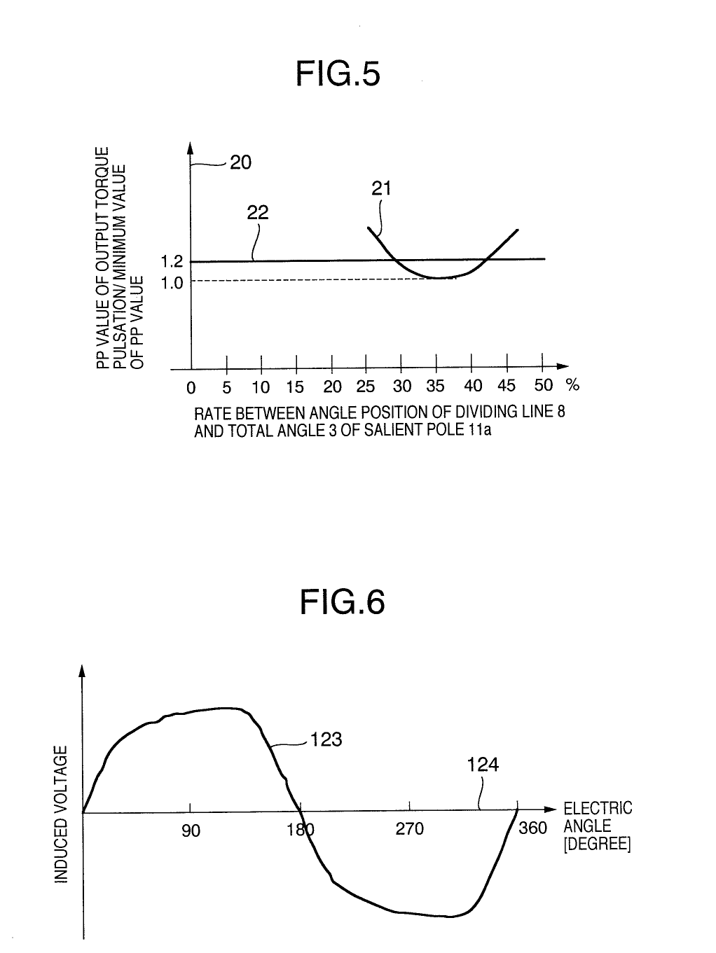

FIG. 5 shows a pp value 21 of the output torque pulsation of the motor in which a minimum value is standardized to 1, in the case that the angle position of the parting line 8 in FIG. 1 is shown by a rate relative to the whole angle 3 of the salient pole 11a with respect to the rotating direction 2 of the rotor, by an axis of ordinate 20. The minimum value is at a position of 36.5% on the abscissa axis, and the pp value of the output torque pulsation of the motor is increased regardless of increasing or decreasing a magnitude of the angle position of the parting line 8, so that a performance is deteriorated. An increase of the torque pulsation can be allowed up to 20%, an allowable value of the torque pulsation increase is shown by a line 22 which is about 1.2 times of the minimum value, and intersecting points between the line 22 and the graph 21 are determined as 29% and 43% on the abscissa axis. Accordingly, if the value indicating the angle position of the parting line 8 by the rate to an actual length of the salient pole 11a with respect to the rotating direction of the rotor exists between 32% and 42%, the motor has an improved output torque pulsation characteristic.

FIGS. 6 to 8 show a characteristic of the single-phase motor in accordance with the present embodiment. FIG. 6 shows a wave form 123 of an induced voltage generated in the coil on the basis of the rotation of the rotor. An abscissa axis 124 shows an electrical angle, and the drawing shows one cycle of the electrical angle. In this case, a generation point of the induced voltage in FIG. 6 corresponds to, for example, a position at which a rotor 47 in FIG. 16 is rotated at a mechanical angle 4.5 degrees in the rotating direction 2.

Describing in more detail, FIG. 16 shows a result of magnetic field analysis of the present embodiment, and shows a stator core 46, a rotor core 47 and a permanent magnet 49 in the constituting elements of the motor, as mentioned below. As is apparent from the drawing, FIG. 16 shows one half part of a whole. In the drawing, lines having a crude density correspond to lines of magnetic flux in the result of magnetic field analysis. Two poles (SN) exist in an illustrated portion in the magnet 49 in accordance with a distribution of a magnetic flux line and are magnetized in a radial direction. Further, as presumed from the lines of magnetic flux in the drawing, in a cutting line showing that the analysis portion is constituted by one half portion of a whole, in a bottom portion on a paper surface of the drawing, a direction of a pole (SN) of the magnet 49 is switched to a radial direction. Setting a relation of rotational position in the rotating direction 2 between the rotor core 47 and the magnet 49, and the stator core 46 mentioned above to a zero degree of the mechanical angle mentioned above, the induced voltage generated in the coil wound in the teeth portion (not shown) becomes zero, in the positional relation in which the rotor core 47 and the magnet 49 are rotated at the mechanical angle 4.5 degrees in the rotating direction 2, as mentioned above, thereby forming the generation point of the induced voltage in FIG. 6.

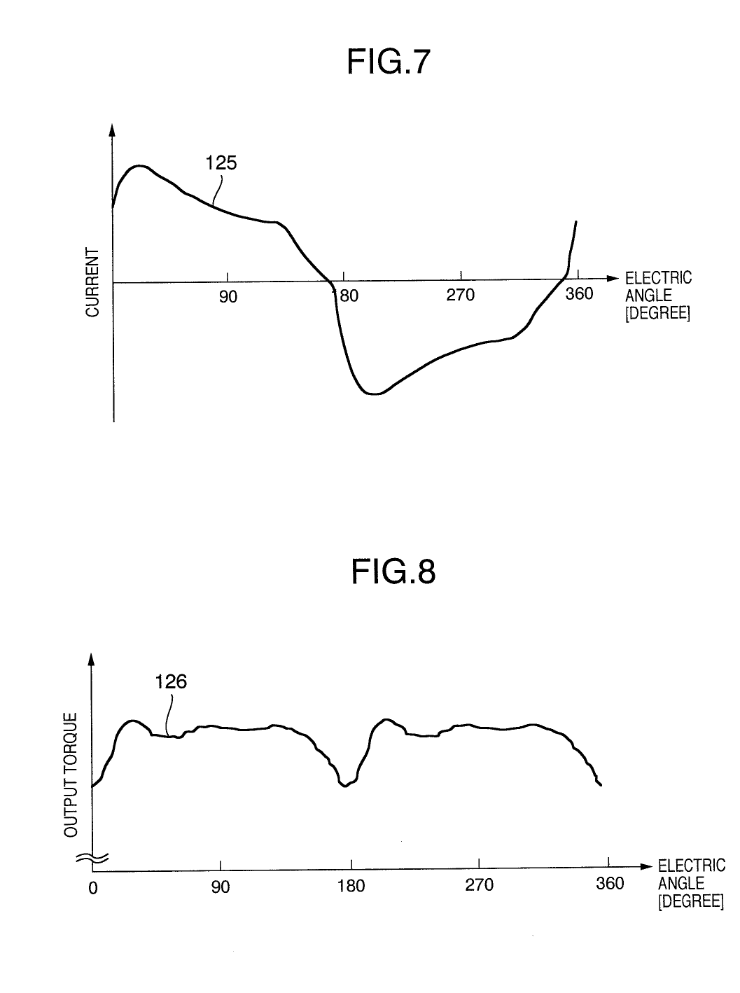

FIG. 7 shows a current 125 circulating through the coil. It is seen that the electric current gently descends in a portion corresponding to the soft switching of the voltage wave form 16 in FIG. 2. In the case that the soft switching is not executed, the electric current in this portion inversely has a peak, and adversely affects the torque pulsation. FIG. 8 shows an output torque wave form 126. The peak of the torque is cut and the high-order torque pulsation is reduced in the portion corresponding to the soft switching, and the shape of the starter core has an effect of reducing the low-order torque pulsation component. As a result, it is seen that there can be obtained a good characteristic in which the torque pulsation is very small.

Next, a second embodiment of the vibration reduction is shown. In the single-phase motor as mentioned above, there is a problem that a vibration damping member such as a vibration proof rubber or the like is necessary for achieving a reduction of vibration propagation due to the torque pulsation of the motor.

The other object of the present invention is to provide a low-noise axial fan motor which can reduce a solid born sound generated on the basis of the vibration of the motor or the like even in states of the axial fan motor itself and being installed in various apparatuses. Specifically, the object is to provide a stator core which can further reduce a vibration and a noise of a fan and a blower, by separating the stator core and a sleeve supporting the stator core, that is, making a contact area between the stator core and the sleeve as small as possible at a time of supporting, thereby making a propagation of the vibration generated in the stator core to the sleeve as small as possible.

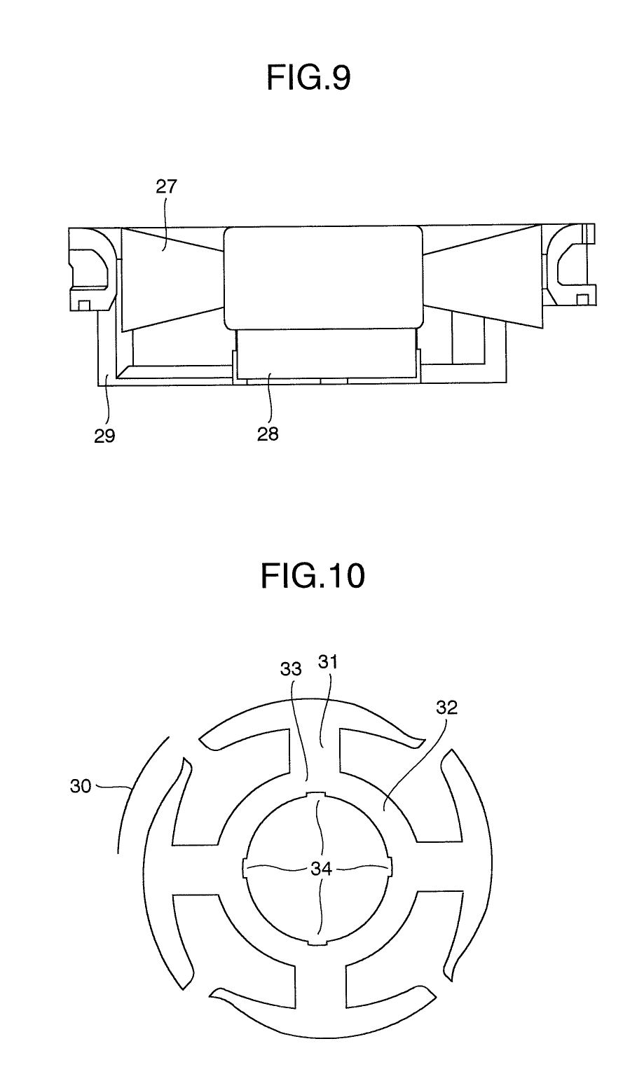

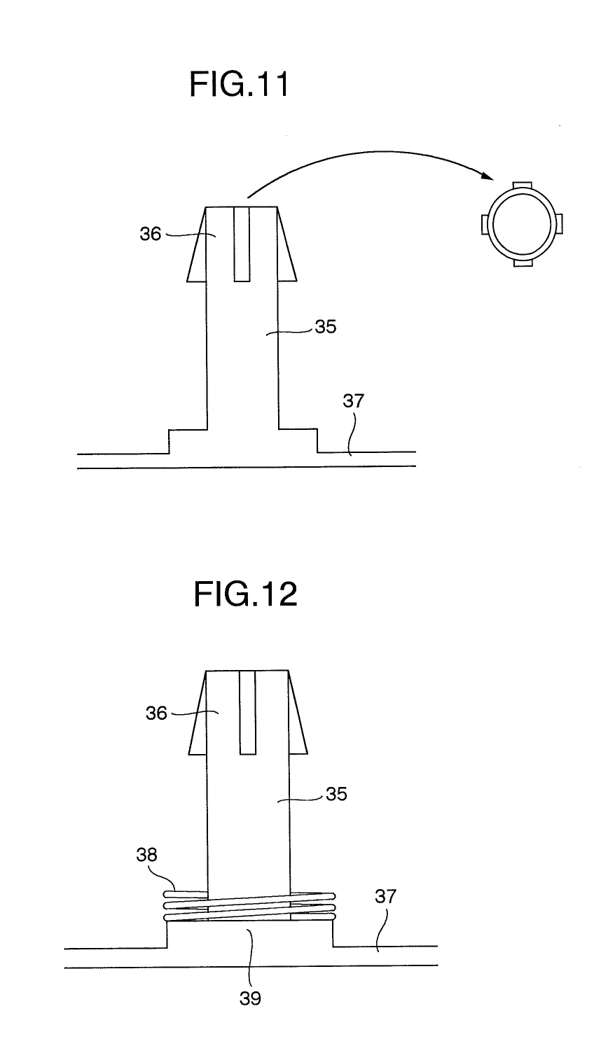

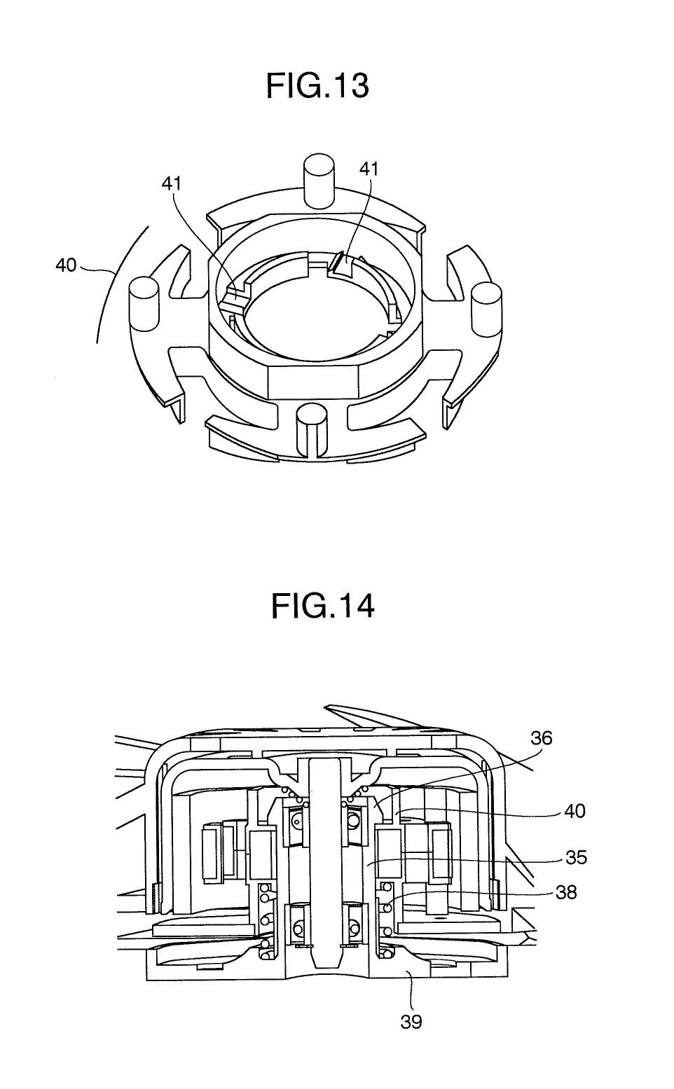

First, FIG. 9 shows a view of a whole structure of the axial fan motor. As shown in the drawing, the axial fan motor is constituted by a propeller 27 rotating so as to generate an air flow, a motor portion 28 driving the propeller, and a venturi 29 provided so as to be spaced from a leading end of an impeller blade of the propeller. FIG. 10 shows a shape of a stator core 30 in accordance with the second embodiment of the present invention. As shown by this drawing, a concave space 34 is provided in an intersecting portion 33 between teeth 31 and a core back 32. The space 34 is provided for the reason that it is necessary to pass through a stopper portion 36 in an upper portion of a sleeve 35 at a time of supporting the stator core 30 and a substrate set to the sleeve 35 shown in FIG. 11. If the propeller 27 is rotated, a vibration caused by the torque pulsation is generated in the stator core 30, however, a vibration reduction of the fan and the blower is achieved in such a manner as to prevent the vibration of the stator core 30 from being directly propagated. Specifically, it is preferable to set a space between the stator core 30 and the sleeve 35 so as to prevent the stator core 30 from being in contact with the sleeve 35. This structure aims at the venturi 29 and a casing 37 which have the sleeve 35 having the structure shown in FIG. 11. If a spring 38 is inserted to the venturi 29, the structure shown in FIG. 12 is obtained. Next, the stator core 30 shown in FIG. 10 and the substrate set are put through the sleeve 35. At this time, if the space 34 in FIG. 10 is put through the stopper portion 36, and a lower insulator 39 and the spring 38 are brought into contact with each other, the stator core 30 and the substrate set are inserted so as to push the spring 38. Further, if the space 34 in FIG. 10 is completely put through the lower portion of the stopper portion 36, it is rotated in such a manner as to be set to a groove 41 holding a stopper in an upper insulator 40 shown in FIG. 13, and it is possible to support the stator core 30 and the substrate set to the sleeve 35 by the stopper portion 36 and the spring 38. FIG. 14 shows a cross sectional view 42 after the operation mentioned above is finished.

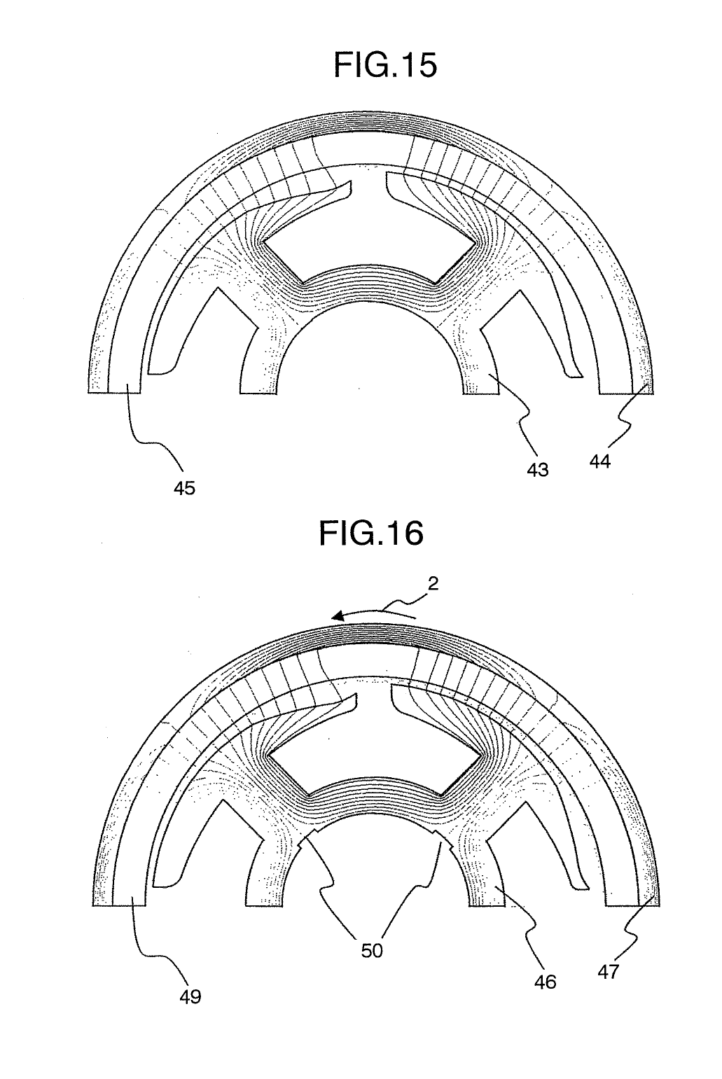

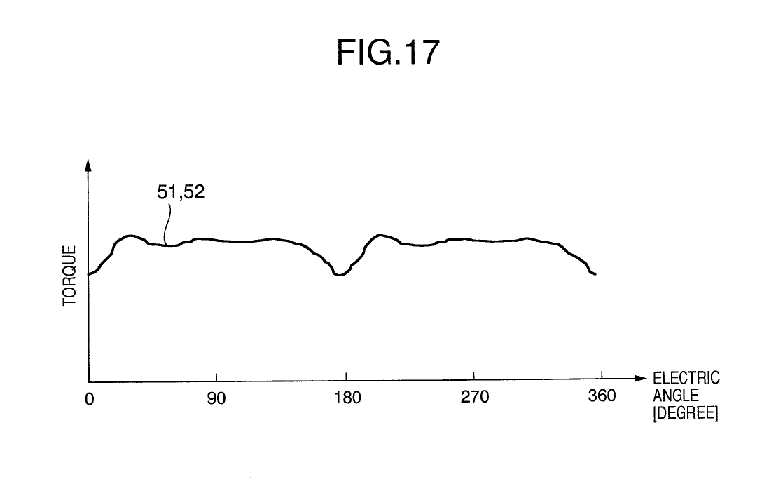

Accordingly, it is possible to obtain the structure in which the stator core and the sleeve are in non-contact with each other, however, in the case of considering the structure mentioned above, since an inner diameter of the stator core is not brought into contact with an outer diameter of the sleeve, it is unavoidable that the inner diameter of the stator becomes larger in some degree than an outer shape of the sleeve. Therefore, there can be considered to give a margin of passage of the stopper by enlarging the inner diameter of the stator core. However, in accordance with this method, the following defects are generated. First, there can be considered that the outer diameter of the stator core is increased in correspondence to the enlargement of the inner diameter of the stator core. The enlargement of the outer diameter of the stator core means a possibility that a motor size is enlarged. In this case, a boss diameter of the fan is enlarged more than necessary, and there is a possibility that a desired fluid performance can not be obtained. In order to prevent the phenomenon mentioned above, a stator core shape as shown in FIG. 10 is invented. This shape corresponds to a shape which satisfies a desired motor performance at a desired stator core size. FIG. 15 shows a result of magnetic field analysis in the stator core which does not have the space 34 in FIG. 10. On the other hand, FIG. 16 shows a result of magnetic field analysis of the embodiment in accordance with the present invention. FIGS. 15 and 16 show necessary parts for the magnetic field analysis, that is, only the stator cores 43 and 46, the rotor cores 44 and 47, and the permanent magnets 45 and 49. FIGS. 15 and 16 show a flow of lines of magnetic flux. Since the space 50 for putting the stopper of the sleeve through is provided in a place in which a magnetic flux density is lowest in an inner diameter portion of the stator core 46, the flow of the magnetic flux is approximately uniform regardless of existence of the space 50. From these two results of analysis, it is seen that both the motor performances are not different, and it is seen that the shape of the present embodiment does not deteriorate the motor performance, and is optimum for the structure in which the motor vibration is not directly propagated to the sleeve. FIG. 17 shows torque ripples 51 and 52 of the motor which does not have the space 34 in FIG. 10 and the motor in accordance with the present embodiment. From this drawing, it is seen that no difference is generated in the motor performances.

Further, in a society in which a reuse of a resource is called, a product which can be reused by being disassembled is desirable for an industrial product. From this point of view, it is important to manufacture the product in such a manner as to reuse as many parts as possible. In the manufacturing of the conventional fan motor and blower, the stator core and the sleeve supporting the stator core are assembled in accordance with adhering, caulking or welding method. If the stator core is fixed to the sleeve in accordance with these methods, the sleeve can be disassembled only by being broken, so that it is impossible to reuse the resource. In the present invention, since the stator core and the sleeve are not firmly brought into direct contact with each other by the adhesion, the adhesive material or the like, it is possible to easily disassemble. Accordingly, it is possible to provide the structure in which the recycle can be easily achievable.

Further, the structure can be made such that each of spaces is provided at an intersecting position between an inner diameter of a core back and a root portion 50 of the teeth portion, and the space is used as a positioning for a former of the coil.

As mentioned above, in accordance with the present invention, it is possible to provide the single-phase motor having the small torque pulsation, the low noise and the low vibration. Further, since the structure is made such that the motor stator core and the sleeve are not directly brought into contact with each other, and the vibration of the stator core is damped so as to reach the sleeve in such a manner that the influence of the magnetic flux flow is cut as much as possible, and the motor efficiency becomes maximum, it is possible to reduce the vibration of the fan. On the basis of the reduction of the fan vibration, it is possible to achieve the low vibration and the low noise of the office automation (OA) and information technology (IT) devices and household appliances in which the fan is installed and mounted. Further, since it is possible to easily disassemble, it is possible to reuse the disassembled stator core, venturi and the like.

It should be further understood by those skilled in the art that although the foregoing description has been made on embodiments of the invention, the invention is not limited thereto and various changes and modifications may be made without departing from the spirit of the invention and the scope of the appended claims.

1. A single-phase motor comprising a rotor magnet, a stator core having salient poles, and a coil wound around the stator core, wherein a rising portion and a falling portion of a voltage applied to said coil have different inclinations, said salient pole is separated into three angle portions, a radius of an outer shape of said salient pole is reduced little by little with respect to a rotating direction of said rotor in a first angle portion with respect to the rotating direction of said rotor, is increased little by little with respect to the rotating direction of said rotor in a second angle portion with respect to the rotating direction of said rotor, and is increased little by little with respect to the rotating direction of said rotor in a third angle portion with respect to the rotating direction of said rotor, and a rate of increase in said third angle portion is gentler than that in said second angle portion.

2. A single-phase motor as claimed in claim 1, wherein said applied voltage is applied before generation of a motor induced voltage, and a lead angle of said applied voltage is in a range between 0 degree and 10 degrees in an electrical angle.

3. A single-phase motor as claimed in claim 1, wherein said first angle is in a range from 4% to 13% of a whole angle of said salient pole, and said second angle is in a range from 29% to 43% of the whole angle of said salient pole.

4. A single-phase motor as claimed in claim 1, wherein a rising angle of said applied voltage is substantially in a rectangular shape, and a falling portion thereof is in a range from 40 degrees to 50 degrees of one half cycle of said applied voltage.

5. A single-phase motor as claimed in claim 1, wherein said stator core is supported to a sleeve having projections, and an inner diameter of said core is structured in such a manner as to be prevented from being interfered with the projections of said sleeve.

6. A single-phase motor as claimed in claim 1, wherein said stator core is supported to a sleeve having projections, and each of spaces is provided at a respective position where a support pole and a core back intersect.

7. A single-phase motor as claimed in claim 6, wherein said projection or projections of said sleeve pass through at least one of said spaces.

8. A single-phase motor as claimed in claim 6, wherein said space is constituted by a concave portion, and is provided on an inner diameter side of said stator core.

9. A single-phase motor as claimed in claim 1, wherein said stator core is supported to a sleeve having projections, each of spaces is provided at a respective position where an inner diameter of a core back and the core back intersect, and the space is used for positioning a former of a coil.
